(19) United States
(12) Patent Application Publication
(10) Pub. No.: US 2026/0284951 A1
(43) Pub. Date: Sep. 24, 2026

(54) EXTRUDED FLUORESCENT FILMS

(71) Applicant: UbiQD, Inc., Los Alamos, NM (US)

(72) Inventors: Karthik RAMASAMY, White Rock, NM (US); Matthew BERGREN, Los Alamos, NM (US); Hunter MCDANIEL, Los Alamos, NM (US)

(21) Appl. No.: 19/490,136

(22) PCT Filed: Jun. 13, 2024
(86) PCT No.: PCT/US2024/033794

§ 371 Date: Dec. 4, 2025

Related U.S. Application Data
(60) Provisional application No. 63/507,769, filed on Jun. 13, 2023.

(51) Int. Cl. B29C 48/18; B29C 48/00; B29C 48/40; B29K 96/02; B29L 7/00; B29L 31/00

(52) U.S. Cl. CPC B29C 48/185; B29C 48/0018; B29C 48/022; B29C 48/40; B29K 2096/02; B29K 2995/0035; B29L 2007/008; B29L 2031/7006

(57) ABSTRACT

Optical elements and compositions are provided which include an extruded polymer and a plurality of fluorophores or color pigments disposed within. The fluorescent compositions have quantum yields greater than 50% and are stable in performance over long durations of time under oxygen, moisture, and light exposure. In some embodiments, the extruded polymer is prepared as pellets, microparticles, nanoparticles, or films.

### FIELD OF THE DISCLOSURE

The present disclosure relates generally to color pigments, fluorescent materials and extruded films, and more specifically to co-extruded fluorescent materials and polymers that are robust against oxygen, carbon dioxide, and/or moisture transmission and that are stable under long-term exposure to light while limiting the number of film layers and complexity.

### BACKGROUND OF THE DISCLOSURE

Luminescent films are particularly useful in applications involving spectral sensitivity such as agriculture and solar energy, where they can be used to modify incoming light for improved crop growth or electricity conversion. They may also be used in other applications, including window coatings and displays. One significant challenge associated with luminescent films is their tendency for the fluorophore to degrade under long-term light exposure and in the presence of oxygen or moisture. Oxygen and moisture diffuse through all polymeric materials; however, the material choice and structure may limit that diffusion of water, oxygen, carbon dioxide, or mixtures of gasses, and may minimize at least one part of the degradation mechanism. Utilizing multi-layer film structures allows for different film properties to be optimized separately.

Extrusion is a widely used technique in the fabrication of functional plastics, including agricultural films and food packaging. For example, blown film extrusion is commonly used to prepare greenhouse cover and sileage films with up to eleven layers. Various polymers have been utilized in extrusion multi-layer films, including acrylics, polyethylene (PE), ethylene vinyl acetate (EVA), polyvinyl alcohol (PVOH), and ethylene vinyl alcohol (EVOH). Tie-layers, such as maleic anhydride grafted polyethylene and maleic anhydride grafted ethylene vinyl acetate, are used in multi-layer structures to adhere layers that would otherwise not have good adhesion. Maleic anhydride has both hydrophobic and hydrophilic regions on the molecule allowing it to bridge between polar and non-polar layers in a multilayer structure.

Quantum dots (QDs) are exemplary fluorescent materials that have the potential to modify light spectra to improve application performance. A good example of this is in agriculture, where QDs have been used to create the lighting conditions that are most conducive to plant growth, see, e.g., commonly assigned WO2018209000A1 (McDaniel et al.), entitled “Luminescent Optical Elements for Agricultural Applications”.

### BRIEF DESCRIPTION OF THE DRAWINGS

FIG. 1 shows a schematic of multilayer film, where P is maleic anhydride grafted LLDPE, maleic anhydride grafted EVA, ethylene vinyl alcohol, thermoplastic polyurethane, or nylon.

FIG. 2 shows: (a) a picture of quantum dots (QDs) loaded LLDPE obtained from example 3; and (b) a picture of 7-layer blown film obtained from example 10.

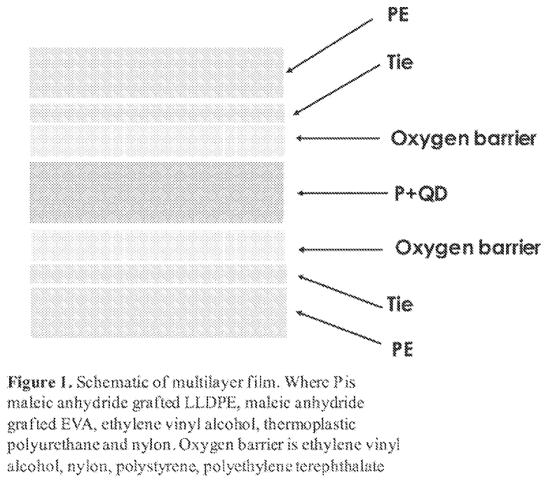

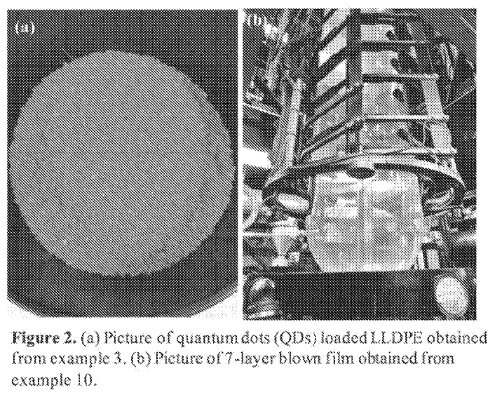

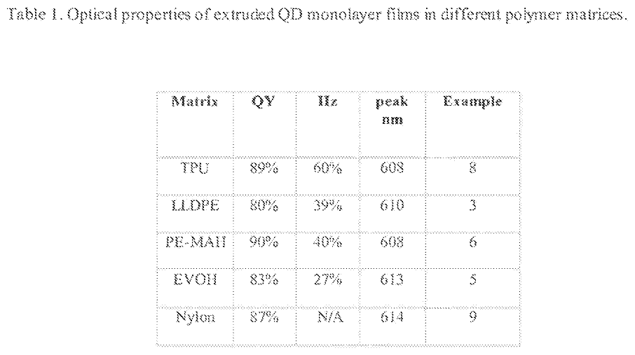

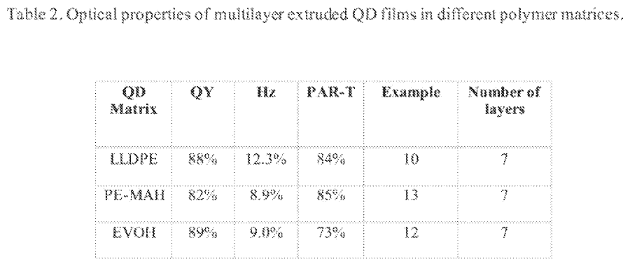

Table 1 shows optical properties of extruded QD monolayer films in different polymer matrices.

Table 2 shows optical properties of multilayer extruded QD films in different polymer matrices.

### SUMMARY

In one aspect, optical elements and compositions are provided which include an extruded polymer film, and a plurality of fluorophores disposed within. The fluorescent compositions have quantum yields greater than 50% and are stable in performance over multiple years' time under oxygen, moisture, and light exposure. The extruded film contains at least one layer having at least 1 wt % ethylene vinyl alcohol polymer copolymer and at least one tie-layer. In some embodiments, the tie layer contains the fluorophores. In some embodiments, the extruded polymer is prepared as pellets, microparticles, nanoparticles, or films. In some embodiments, there can be included at least one layer that contains additives for stabilizing polymers against light degradation. In other embodiments there can be included at least one layer that contains antioxidants or other sacrificial additives for slowing oxygen ingress.

In another aspect of the invention, a composition is provided including an extruded copolymer of maleic anhydride grafted polyethylene or maleic anhydride grafted ethylene vinyl acetate, and a plurality of color pigments disposed in the extruded polymer, herein the pigments are present at greater than 0.5 mol percent and wherein the composition maintains its optical properties within 20 percent of its initial levels over one year of sunlight exposure. The optical property may be any one of the color index values, or may be optical density, or may be fluorescence quantum yield, or may be light transmission.

In yet another aspect of the invention, a greenhouse covering is provided including an extruded polymer film having multiple layers and a plurality of fluorophores disposed in at least one layer of the extruded polymer film and wherein the fluorophores have a quantum yield greater than 50% and wherein the polymer film limits outgassing of CO₂ from the greenhouse to less than 10 cm³ per m² per day. The fluorophores can be quantum dots. Also, the polymer film of the greenhouse covering can further contain either: at least one layer having at least 1 weight percent ethylene vinyl alcohol polymer copolymer; or, at least one layer having maleic anhydride.

### DETAILED DESCRIPTION

Polymeric films are the simplest matrix for QDs. However, QDs can degrade when exposed to both light and oxygen for long durations of time, and films generally have a high surface area to volume ratio that allows for gas ingress. Few polymers limit gas diffusion on their own. Frequently, polymers require a ceramic coating in order to achieve a low oxygen transmission rate (OTR), for example less than 10 cm³ per m² per day. However, this process is costly and is generally not possible in combination with extrusion manufacturing techniques. Additionally, low OTR typically corresponds to low transmission rates of other gases, like CO₂. This could benefit greenhouses that dose with CO₂ because the gas leakage would be reduced enabling less waste, and more efficient use of CO₂.

Food-grade barrier films can limit oxygen diffusion to preserve food and could potentially solve this problem, but they are not engineered to be exposed to sunlight and other outdoor environmental conditions. Similarly, silage films often have a similar make up, but usually are only designed for a single-use and without light transmission. Typically, food grade and sileage barrier films have several layers, where each layer is chosen for to provide low water vapor transmission rate (WVTR) or oxygen transmission rate (OTR) properties (but typically not both). By building up those layers, a polymer with relatively low OTR and WVTR may be produced. Moreover, since these polymers are readily available and the manufacturing methods include extrusion, products that include these materials are typically affordably priced.

### Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly indicates otherwise. The term “or” refers to a single element of stated alternative elements or a combination of two or more elements unless the context clearly indicates otherwise.

Unless explained otherwise, all technical and scientific terms used herein have the same meaning as commonly understood to one of ordinary skill in the art to which this disclosure relates. Suitable methods and compositions are described herein for the practice or testing of the compositions, systems and methodologies described herein. However, it is to be understood that other methods and materials similar or equivalent to those described herein may be used in the practice or testing of these compositions, systems, and methodologies. Consequently, the compositions, materials, methods, and examples disclosed herein are illustrative only, and are not intended to be limiting. Other features of the disclosure will be apparent to those skilled in the art from the following detailed description and the appended claims.

Unless otherwise indicated, all numbers expressing quantities of components, percentages, temperatures, times, and so forth, as used in the specification or claims are to be understood as being modified by the term “about.” Unless otherwise indicated, non-numerical properties such as colloidal, continuous, crystalline, and so forth as used in the specification or claims are to be understood as being modified by the term “substantially,” meaning to a great extent or degree. Accordingly, unless otherwise indicated implicitly or explicitly, the numerical parameters and/or non-numerical properties set forth are approximations that may depend on the desired properties sought, the limits of detection under standard test conditions or methods, the limitations of the processing methods, and/or the nature of the parameter or property. When directly and explicitly distinguishing embodiments from discussed prior art, the embodiment numbers are not approximations unless the word “about” is recited.

Photoluminescence (PL): The emission of light (electromagnetic radiation, photons) after the absorption of light. It is one form of luminescence (light emission) and is initiated by photoexcitation (excitation by photons).

Toxic: Denotes a material that can damage living organisms due to the presence of phosphorus or heavy metals such as cadmium, lead, or mercury.

Quantum Dot (QD): A nanoscale particle that exhibits size-dependent electronic and optical properties due to quantum confinement. The quantum dots disclosed herein preferably have at least one dimension less than about 50 nanometers. The disclosed quantum dots may be colloidal quantum dots, i.e., quantum dots that may remain in suspension when dispersed in a liquid medium. Some of the quantum dots which may be utilized in the compositions, systems and methodologies described herein are made from a binary semiconductor material having a formula MX, where M is a metal and X typically is selected from sulfur, selenium, tellurium, nitrogen, phosphorus, arsenic, antimony, or mixtures thereof. Exemplary binary quantum dots which may be utilized in the compositions, systems and methodologies described herein include CdS, CdSe, CdTe, PbS, PbSe, PbTe, ZnS, ZnSe, ZnTe, InP, InAs, Cu₂S, and In₂S₃. Other quantum dots which may be utilized in the compositions, systems and methodologies described herein are ternary, quaternary, and/or alloyed quantum dots including, but not limited to, ZnSeₓS₁₋ₓ, ZnTeₓSe₁₋ₓ, ZnTeₓS₁₋ₓ, CdSeₓS₁₋ₓ, CdTeₓSe₁₋ₓ, CdTeₓS₁₋ₓ, HgSeₓS₁₋ₓ, HgTeₓSe₁₋ₓ, HgTeₓS₁₋ₓ, ZnCdS, ZnCdSe, ZnCdTe, ZnHgS, ZnHgSe, ZnHgTe, CdHgS, CdHgSe, CdHgTe, ZnCdSeₓS₂₋ₓ, ZnCdSeₓTe₂₋ₓ, ZnHgSeₓTe₂₋ₓ, ZnHgSeₓS₂₋ₓ, CdHgSeₓS₂₋ₓ, CdHgSeTe, CuAlS₂, CuInS₂, CuInSe₂, CuInTe₂, CuInGaSe₂, CuInZnS₂, CuZnSnSe₂, CuInSeₓS₂₋ₓ, CuInZnSeₓS₂₋ₓ, (Cu_{y}Ag_{1-y})InSeₓS₂₋ₓ, AgInS₂, AgInSe₂, and AgInSeₓS₂₋ₓ quantum dots, where 0≤x≤2, although the use of non-toxic quantum dots is preferred. Embodiments of the disclosed quantum dots may be of a single material or may comprise an inner core and an outer shell (e.g., a thin outer shell/layer formed by any suitable method, such as cation exchange). The quantum dots may further include a plurality of ligands bound to the quantum dot surface.

Quantum Yield (QY): The ratio of the number of emitted photons to the number of absorbed photons for a fluorophore.

Fluorophore: a material which absorbs a first spectrum of light and emits a second spectrum of light.

Stokes shift: the difference in energy between the positions of the absorption shoulder or local absorption maximum and the maximum of the emission spectrum.

Emission spectrum: Those portions of the electromagnetic spectrum over which a photoluminescent material exhibits photoluminescence (in response to excitation by a light source) whose amplitude is at least 1% of the peak PL emission.

Polymer: A large molecule, or macromolecule, composed of many repeated subunits. Such polymers range from familiar synthetic plastics such as polystyrene or poly(methyl methacrylate) (PMMA), to natural biopolymers such as DNA and proteins that are fundamental to biological structure and function. Polymers, both natural and synthetic, are created via polymerization of many small molecules, known as monomers. One useful class of polymers are maleic anhydride grafted polymers where maleic anhydride can be grafted onto a suitable polymer backbone. The backbone for the grafting of the maleic anhydride is often a polyolefin (polyethylene, polypropylene, ethylene vinyl alcohol and the like) but could also be other types of polymers. Exemplary polymers include maleic anhydride-grafted polyethylene, maleic anhydride-grafted ethylene vinyl acetate, poly(methyl methacrylate) (PMMA), maleic anhydride grafted polyethylene vinyl alcohol, ethylene vinyl acetate (EVA), ethylene vinyl alcohol (EVOH), polyethylene vinyl alcohol (PVOH), polyamides such as nylon, polystyrene, polycarbonate, polyethylene terephthalate (PET), ionoplasts, polyolefins (POE), silicones, and epoxy resins.

Self-absorption: The percentage of emitted light from a plurality of fluorophores that is absorbed by the same plurality of fluorophores. Some quantum dots, including CuInS₂, CuInSe₂, CuInGaSe₂, CuAlS₂, CuInZnS₂, CuZnSnSe₂, CuInSeₓS₂₋ₓ, CuInZnSeₓS₂₋ₓ, and AgInSeₓS₂₋ₓ, where 0≤x≤2, and related compounds, are known to have uniquely low self-absorption owing to the large Stokes shift between the absorption and emission spectrum of typically greater than 100 meV (~30 nm at 600 nm peak emission).

### DESCRIPTION OF SPECIFIC EMBODIMENTS

It is a goal of the present disclosure to create a low-cost extruded fluorescent film that maintains its optical properties after long-term light exposure in the presence of oxygen and/or moisture. It has previously been demonstrated that ‘electronics grade’ barrier films can protect fluorophores; however, this approach is expensive, and does not scale well. By utilizing extruded polymers with barrier properties (preferably ethylene vinyl alcohol polymer copolymers), various fluorophores (including, but not limited to, quantum dots) may be rendered surprisingly stable under light exposure in the presence of oxygen or moisture. Moreover, compounding the fluorophores within tie-layer polymers can enable greater simplicity in the manufacturing process, potentially reducing the number of layers required to achieve a low OTR.

In embodiments of the present invention, a layered film structure is used to protect the fluorophores with one layer containing QDs with peak emission at 600 nm. Layers within the multilayer structure include polymer materials having low oxygen transmission rates (OTR) and low water vapor transmission rates (WVTR). A fluorophore containing layer generally contains between 0.1 and 10 wt % fluorophores. After over 2 weeks under blue light at 50° C. (accelerated aging conditions), the film was found to maintain at least 90% of its quantum yield (QY), compared to 0% for a polymer that has not been engineered for low OTR. In some embodiments, the QDs have vinyl alcohol or ethylene derivatives chemically bonded on to their surfaces to enhance solubility of in the matrix and further limit oxygen or water ingress. The polymer may take various form factors. Thus, for example, the polymer may be in the form of a film (which may be planar or non-planar), or beads or pellets that may be used as a feedstock to make films. By way of specific example, the polymer may be shaped as small 10 nm-1000 μm (micron) sized particles. Ideally, the multilayer structure has an OTR value of less than 5 cm³ per m² per day at 50% relative humidity and 20° C. for a 1 mil thick film. Additionally, the multilayer structure should have a WVTR value of less than 100 g per m² per day at 90% relative humidity and 40° C. for a 1 mil thick film. Moreover, such a structure can provide protection against gas diffusion from both directions (above and below), which is important when the fluorophores can be degraded by the presence of the gas.

Various modifications, substitutions, combinations, and ranges of parameters may be made or utilized in the compositions, devices and methodologies described herein.

For example, in some embodiments, the photoluminescence of the luminescent material may have a maximum intensity at wavelengths in the range of 400 nm to 2000 nm, more preferably in the range of 550 nm to 1700 nm, and most preferably in the range of 550 nm to 750 nm. In some embodiments, the fluorophores may emit a spectrum of light having full-width at maximum intensity that is greater than 1 nm, greater than 20 nm, greater than 30 nm, greater than 40 nm, greater than 100 nm, or greater than 200 nm. In other embodiments, the photoluminescence of the luminescent material may have a maximum intensity at wavelengths greater than 550 nm.

In some embodiments, the photoluminescence of the luminescent material may be characterized by a quantum yield of at least 30%, at least 50%, at least 70%, or at least 80%.

Various optical elements may be utilized in the optical paths of the devices and methodologies described herein. For example, in some embodiments, a spectrum selecting optical element may be placed in the optical path between the irradiated article and the incident sunlight. Such an optical element may include, for example, one or more elements selected from the group consisting of light filters, quantum dot films and colored glasses. A spectrum selecting optical element of this type may allow only a given portion of the spectrum to pass.

Quantum Dots (QDs) and fluorophores of various compositions may be utilized in the systems and methodologies disclosed herein. Some of these compositions have been noted above. In some embodiments of the systems and methodologies described herein, QDs and fluorophores having compositions selected from the group consisting of CuInS₂, CuInSe₂, AgInS₂, AgInSe₂, ZnS, ZnSe, CuInZnSeS, CuGaS₂, CuAlS₂ and alloys of the foregoing, may be utilized. However, in many embodiments of the systems and methodologies disclosed herein, the use of QDs and fluorophores having the composition CuInSeₓS₂₋ₓ/ZnS are preferred.

In some embodiments, two or more distinct types of quantum dots may be utilized in the systems, methodologies and compositions described herein. These quantum dots may be compositionally distinct. For example, the luminescent materials utilized herein may comprise a first type of quantum dot based on a first chemistry, and a second type of quantum dot based on a second chemistry which is distinct from the first chemistry. Thus, for example, the first type of quantum dot may comprise, for example. CuInS₂, while the second type of quantum dot may comprise AgInSe₂ or CuAlS₂. Similarly, the luminescent materials described herein may comprise a first type of quantum dot based on a first set of dimensions (or distribution of dimensions) of the quantum dots, and a second type of quantum dot based on a second set of dimensions (or distribution of dimensions) of the quantum dots which is distinct from the first set of dimensions (or distribution of dimensions) of the quantum dots. Thus, for example, the first type of quantum dot may comprise generally spherical quantum dots having a first diameter (e.g., 10 nm), and the second type of quantum dot may comprise generally spherical quantum dots having a second diameter (e.g., 30 nm).

In preferred embodiments, optical elements are provided which include a polymer film containing at least one layer comprising an ethylene vinyl alcohol polymer copolymer and at least one layer comprising a maleic anhydride-grafted polymer. This ethylene vinyl alcohol polymer copolymer preferably contains at least 20% molar fraction of ethylene, more preferably between 20 and 70% molar fraction of ethylene, and most preferably between 20 and 50% molar fraction of ethylene. In some embodiments and applications thereof, this amount of ethylene is found to impart high resistance to moisture and oxygen permeability in the resulting film or optical element, without compromising other desirable attributes of the film or optical element.

In some embodiments, the optical element is provided with an extruded polymer film that includes at least one layer of an aliphatic polyamide further includes a plurality of fluorophores having a quantum yield of greater than about 75%.

In embodiments of the optical elements and compositions disclosed herein, the polymers used in these elements to impart moisture or oxygen resistance may have various OTR and WVTR values, and these values may depend, for example, on the atmosphere the optical element or composition is likely to encounter during its use, on the choice of matrix material for the layer(s) containing the fluorophore(s), and on other such factors. Preferably, these polymers have an OTR value of less than 10 cm³ per m² per day at 50% relative humidity and 20° C. for a 1 mil thick film, more preferably less than 1 cm³ per m² per day at 50% relative humidity and 20° C. for a 1 mil thick film (~25 μm), and most preferably less than 0.1 cm³ per m² per day at 50% relative humidity and 20° C. for a 1 mil thick film. Preferably, these polymers have a WVTR value of less than 100 g per m² per day at 90% relative humidity and 40° C. for a 1 mil thick film, more preferably less than 50 g per m² per day at 90% relative humidity and 40° C. for a 1 mil thick film, even more preferably less than 30 g per m² per day at 90% relative humidity and 40° C. for a 1 mil thick film, and most preferably less than 5 g per m² per day at 90% relative humidity and 40° C. for a 1 mil thick film.

The devices, structures and methodologies disclosed herein have frequently been described herein in reference to their use in sunlight-exposed applications in general, and fluorescent materials in particular. However, one skilled in the art will appreciate that these devices, structures and methodologies may be employed in various other applications as well including, for example, indoor applications or non-fluorescent materials such as traditional pigments.

### EXAMPLES

The following examples are non-limiting and are merely intended to further illustrate the compositions, systems and methodologies described herein.

### Example 1

Preparation of QD Liquid Concentrate (QDLC) in bis(ethylhexyl) Sebacate

In a typical process, CuInS₂/ZnS quantum dots (from Strem, catalogue no: 29-8510; 29-8520 & 29-8530) were dissolved in bis(ethylhexyl) sebacate at within 70-95% QD concentration by weight to produce QD liquid concentrate in bis(ethylhexyl) sebacate. The liquid concentrate is then fed into an extrusion process wherein it is compounded into maleic anhydride grafted LDPE (PE-MAH), with a resulting quantum yield greater than 75%.

### Example 2

### Preparation of QD Liquid Concentrate (QDLC) in Octadecene

In a typical process, CuInS₂/ZnS quantum dots (from Strem, catalogue no: 29-8510; 29-8520 & 29-8530) were dissolved in octadecene at within 70-95% QD concentration by weight to produce QD liquid concentrate in octadecene. The liquid concentrate is then fed into an extrusion process wherein it is compounded into maleic anhydride grafted LDPE (PE-MAH), with a resulting quantum yield greater than 75%.

### Example 3

### Twin Screw Extrusion of QDs in LLDPE

In a twin extruder, linear low density polyethylene (LLDPE) pellets were introduced through the hopper while in another port, QD liquid concentrate from each individual sample from examples 1 and 2 was introduced (LLDPE to QDLC ratio varied from 2% to 50%) into the extruder at 180° C. and the resultant strands were chopped to produce pellets of blended material. The loading of quantum dots in pellets varied from 1% to 47.5%. The pellets were taken for the multilayer film extrusion through a single screw extruder. The resulting film maintains photostability under sunlight exposure, with QY greater than 50% for at least three years.

### Example 4

### Twin Screw Extrusion of QDs in EVA

In a twin extruder, ethylene vinyl acetate (EVA) pellets were introduced through the hopper while in another port, QD liquid concentrate from each individual sample from examples 1 and 2 was introduced (EVA to QDLC ratio varied from 2% to 50%) into the extruder at 150° C. and the resultant strands were chopped to produce pellets of blended material. The loading of quantum dots in pellets varied from 1% to 47.5%. The pellets were taken for the multilayer film extrusion through a single screw extruder. The resulting film maintains mechanical stability under sunlight exposure, without any embrittlement or other mechanical failures for at least two years.

### Example 5

### Twin Screw Extrusion of QDs in EVOH

In a twin extruder, ethylene vinyl alcohol (EVOH) pellets were introduced through the hopper while in another port, QD liquid concentrate from each individual sample from examples 1 and 2 was introduced (EVOH to QDLC ratio varied from 2% to 50%) into the extruder at 220° C. and the resultant strands were chopped to produce pellets of blended material. The loading of quantum dots in pellets varied from 1% to 47.5%. The pellets were taken for the multilayer film extrusion through a single screw extruder.

### Example 6

### Twin Screw Extrusion of QDs in Maleic Anhydride Grafted LDPE (PE-MAH)

In a twin extruder, linear low density polyethylene (PE-MAH) pellets were introduced through the hopper while in another port, QD liquid concentrate from each individual sample from examples 1 and 2 was introduced (PE-MAH to QDLC ratio varied from 2% to 50%) into the extruder at 180° C. and the resultant strands were chopped to produce pellets of blended material. The loading of quantum dots in pellets varied from 1% to 47.5% with a resulting quantum yield greater than 75%. The pellets were taken for the multilayer film extrusion through a single screw extruder. The resulting film maintains photostability under sunlight exposure, with QY greater than 50% for at least three years. The resulting film maintains mechanical stability under sunlight exposure, without any embrittlement or other mechanical failures for at least two years.

### Example 7

### Twin Screw Extrusion of QDs in Maleic Anhydride Grafted EVA (EVA-MAH)

In a twin extruder, maleic anhydride grafted EVA (EVA-MAH) pellets is introduced through the hopper and in another port, QD liquid concentrate from each individual sample from examples 1 and 2 is introduced (EVA-MAH to QDLC ratio varied from 2% to 50%) into the extruder at 150° C. and the resultant strands are chopped to produce pellets of blended material. The loading of quantum dots in pellets varied from 1% to 47.5%. The pellets are taken for the multilayer film extrusion through a single screw extruder. The resulting film maintains photostability under sunlight exposure, with QY greater than 50% for at least three years. The resulting film maintains mechanical stability under sunlight exposure, without any embrittlement or other mechanical failures for at least two years.

### Example 8

### Twin Screw Extrusion of QDs in Thermoplastic Polyurethane (TPU)

In a twin extruder, Thermoplastic Polyurethane (TPU) pellets was introduced through the hopper while in another port, QD liquid concentrate from each individual sample from examples 1 and 2 was introduced (LLDPE to QDLC ratio varied from 2% to 50%) into the extruder at 165° C. and the resultant strands were chopped to produce pellets of blended material. The loading of quantum dots in pellets varied from 1% to 60%. The pellets were taken for the multilayer film extrusion through a single screw extruder.

### Example 9

### Twin Screw Extrusion of QDs in Nylon

In a twin extruder, nylon (6434B grade, Polyamide 6/6.6/12, UBE Chemical) pellets were introduced through the hopper while in another port, QD liquid concentrate from each individual sample from examples 1 and 2 was introduced (Nylon to QDLC ratio varied from 2% to 40%) into the extruder at 205° C. and the resultant strands were chopped to produce pellets of composite material. The loading of quantum dots in pellets varied from 1% to 47.5%. The pellets were taken for subsequent multilayer film extrusion through a single screw extruder.

### Example 10

### Extrusion of Multilayer QD Blown Film

In a multilayer blown film set-up containing up to 9 single screw extruders (from A to I), plastic pellets containing QDs from example 3 were mixed with maleic anhydride grafted LLDPE pellets and the mixture was introduced into the extruder E, extruders A, B, H & I were filled with LLDPE, extruders C & G were filled with maleic anhydride blended LLDPE and extruders D & F were filled with ethylene vinyl alcohol pellets. All the above extruders were operated with temperature varying from 180° C. to 220° C. and the resultant extrudate was blown into a multilayer film. The thickness of multilayer films is varied from 100 μm to 250 μm and the thickness of QD layer is varied from 2 μm to 30 μm.

### Example 11

### Extrusion of Multilayer QD Blown Film

In a multilayer blown film set-up containing up to 9 single screw extruders (from A to I), plastic pellets containing QDs from example 4 is mixed with maleic anhydride grafted EVA pellets and the mixture is introduced into the extruder E, extruders A, B, H & I are filled with LLDPE, extruders C & G are filled with maleic anhydride blended LLDPE and extruders D & F are filled with ethylene vinyl alcohol pellets. All the above extruders are operated with temperature varying from 180° C. to 220° C. and the resultant extrudate is blown into a multilayer film. The thickness of multilayer films is varied from 100 μm to 250 μm and the thickness of QD layer is varied from 2 μm to 30 μm.

### Example 12

### Extrusion of Multilayer QD Blown Film

In a multilayer blown film set-up containing up to 9 single screw extruders (from A to I), plastic pellets containing QDs from example 5 were introduced into the extruder E, extruders A, B, H & I were filled with LLDPE, extruders C & G were filled with maleic anhydride blended LLDPE and extruders D & F were filled with ethylene vinyl alcohol pellets. All the above extruders were operated with temperature varying from 180° C. to 220° C. and the resultant extrudate was blown into a multilayer film. The thickness of multilayer films is varied from 100 μm to 250 μm and the thickness of QD layer is varied from 2 μm to 30 μm.

### Example 13

### Extrusion of Multilayer QD Blown Film

In a multilayer blown film set-up containing up to 9 single screw extruders (from A to I), plastic pellets containing QDs from example 6 was introduced into the extruder E, extruders A, B, H & I were filled with LLDPE, extruders C & G were filled with maleic anhydride blended LLDPE and extruders D & F were filled with ethylene vinyl alcohol pellets. All the above extruders were operated with temperature varying from 180° C. to 220° C. and the resultant extrudate was blown into a multilayer film. The thickness of multilayer films is varied from 100 μm to 250 μm and the thickness of QD layer is varied from 2 μm to 30 μm.

### Example 14

### Extrusion of 5- and 7-Layer QD Blown Film

In a multilayer blown film set-up from example 13, two specific embodiments are specifically considered: (1) a 5-layer structure including two end layers of polyethylene each including a tie layer (also such end layers could be maleic anhydride grafted polyethylene), two layers, one each adjacent to the end layers, made of a polymer of ethylene vinyl alcohol (serving as a gas barrier) and a central layer of maleic anhydride grafted polyethylene further including the desired fluorophore such as the desired quantum dots; and (2) a 7-layer structure including two end layers of polyethylene, two next layers, one each adjacent to the end layers, comprised of maleic anhydride grafted polyethylene, two next layers, one each adjacent to the layers of maleic anhydride grafted polyethylene, made of a polymer of ethylene vinyl alcohol (serving as a gas barrier) and a central layer of maleic anhydride grafted polyethylene further including the desired fluorophore such as the desired quantum dots.

### Example 15

### A Greenhouse Covering

One example of how these materials could be applied in practice, is a highly optimized greenhouse covering comprising an extruded polymer film having multiple layers, a plurality of fluorophores disposed in at least one layer of said extruded polymer film, and where the said fluorophores have a quantum yield greater than 50%, and wherein said polymer film limits the outgassing of CO₂ from the greenhouse to less than 10 cm³ per m² per day. For example, the fluorophores of the greenhouse covering may be or include quantum dots. This greenhouse covering would combine the benefits of stabilized fluorescence on plant photosynthesis, potentially using quantum dots, with the CO₂ barrier properties of at least one layer having at least 1 wt % ethylene vinyl alcohol polymer copolymer, which could be used to maintain elevated levels of CO₂ dosed in the greenhouse to increase plant growth. The greenhouse covering could also contain at least one layer having maleic anhydride to simplify the manufacturing process and reduce costs.

### Example 16

### Sunlight-Stabilized Optical Properties

In many cases, color pigments or other optical materials need to have stabilized properties under sunlight exposure. A novel composition comprising an extruded copolymer of maleic anhydride grafted polyethylene or maleic anhydride grated ethylene vinyl acetate could be used to protect a plurality of color pigments. Ideally, the pigments are present at greater than 0.5 mol %, and wherein said composition maintains its optical property within 20% over one year of sunlight exposure. The key optical property would depend on the application, for example, it could be a color index value (L*a*b* color coordinates, color values, CIELAB, or other color profiles), optical density (degree of light absorption at a particular wavelength), fluorescence quantum yield (efficiency of light emission relative to absorption), or light transmission (for example, of photosynthetically active radiation, PAR).

Although the present invention has been described with reference to specific details, it is not intended that such details should be regarded as limitations upon the scope of the invention. Various modifications, substitutions, combinations, and ranges of parameters may be made or utilized in the compositions, and methodologies described herein.

The above description of the present invention is illustrative and is not intended to be limiting. It will thus be appreciated that various additions, substitutions, and modifications may be made to the above-described embodiments without departing from the scope of the present invention. Accordingly, the scope of the present invention should be construed in reference to the appended claims.

Moreover, it is specifically contemplated that the features described in the appended claims may be arranged in different combinations or sub-combinations without departing from the scope of the present disclosure. For example, it is contemplated that features set forth in two or more claims may be combined into a single claim without departing from the scope of the present disclosure, whether or not the resulting combination of features is explicitly disclosed elsewhere in the appended claims or disclosure.

### Example 16

### A Double Layer Greenhouse Covering

One example of how these materials could be applied in practice, is a highly optimized greenhouse covering comprising two extruded polymer film having multiple layers, a plurality of fluorophores disposed in at least one layer of at least one extruded polymer film, and where the said fluorophores have a quantum yield greater than 50%, and wherein both polymer films limit the outgassing of CO₂ from the greenhouse to less than 10 cm³ per m² per day and CO₂ gas is used to fill the space between the two extruded films. By using CO₂ gas between the two extruded layer coverings instead of air, the heat within the greenhouse can be maintained well due to the greenhouse gas effect. To not leech the CO₂ gas between the two films, both films would need a layer that prevents outgassing of CO₂. This also would also serve to block heat from entering the greenhouse, leading to a more controlled environment inside the greenhouse and less energy needed to maintain the temperature inside the greenhouse.

1. An optical element, comprising:
an extruded polymer film having multiple layers; and
a plurality of fluorophores disposed in at least one layer of said extruded polymer film;
wherein said fluorophores have a quantum yield greater than 50%, and
wherein said polymer film contains at least one layer having at least 1 wt % ethylene vinyl alcohol polymer copolymer and at least one layer including at least 1 wt % maleic anhydride.

2. The optical element of claim 1, wherein said fluorophores emit a spectrum of light having a maximum intensity at wavelengths greater than 400 nm.

3. The optical element of claim 1, wherein said fluorophores are quantum dots.

4. The optical element of claim 1, wherein said fluorophores are quantum dots comprising a material selected from the group consisting of CuInS₂, CuInSe₂, AgInS₂, AgInSe₂, ZnS, ZnSe, CuAlS₂, and alloys of the foregoing.

5. The optical element of claim 1, further comprising polymers that have oxygen or water barrier properties, wherein said fluorophores are dispersed in a polymeric matrix, and wherein said polymeric matrix is distinct from the polymers having oxygen or water barrier properties.

6. The optical element of claim 1, wherein said polymer film comprises layers of polymers selected from the group consisting of: an acrylate, polyethylene, polycarbonate, polyolefin, polyester, polyamide, polyvinyl butyral, ethylene vinyl acetate, ethylene vinyl alcohol, maleic anhydride-grafted polymers, combinations of these polymers or other similar polymers, and blends of these polymers or other similar polymers.

7. The optical element of claim 1, wherein said polymer film contains at least one layer having ethylene vinyl alcohol polymer copolymer containing at least 20% molar fraction of ethylene, containing a molar fraction of ethylene within the range of 20 to 70%, or containing a molar fraction of ethylene within the range of 20 to 50%.

8. The optical element of claim 1, wherein said polymer film contains at least one exterior layer containing a polymer selected from the group consisting of polyethylene and maleic anhydride grafted polyethylene, maleic anhydride grafted polyethylene vinyl alcohol, and maleic anhydride grafted poly(ethyl vinyl acetate).

9. The optical element of claim 1, wherein said polymer film has an OTR value of less than 5 cm³ per m² per day at 50% relative humidity and 20° C. for a 1 mil thick film.

10. The optical element of claim 1, wherein said polymer film has a WVTR value of less than 100 g per m² per day at 90% relative humidity and 40° C. for a 1 mil thick film.

11. The optical element of claim 1, wherein said maleic anhydride-containing layer has different levels of grafting, from 0.2% to 0.2-0.5%, 0.5-1%, or greater than 1%.

12. A greenhouse covering, comprising:
an extruded polymer film having multiple layers; and
a plurality of fluorophores disposed in at least one layer of said extruded polymer film;
wherein said fluorophores have a quantum yield greater than 50%, and
wherein said polymer film limits the outgassing of CO₂ from the greenhouse to less than 10 cm³ per m² per day.

13. A composition, comprising:
an extruded copolymer of maleic anhydride grafted polyethylene or maleic anhydride grated ethylene vinyl acetate; and
a plurality of fluorophores disposed in said extruded polymer;
wherein said fluorophores are present at greater than 0.5 mol %, and
wherein said composition has a quantum yield greater than 50%.

14. The composition of claim 13, wherein said copolymer is composed of pellets of polymer with diameters between 0.1 mm and 1 cm.

15. The composition of claim 13, wherein said copolymer is composed of nano or micro particles of polymer with diameters within the range of 10 nm and 1000 μm.

16. The composition of claim 13, wherein said fluorophores are chemically bonded to at least one polymer group selected from the group consisting of maleic anhydride grafted polyethylene, maleic anhydride grafted ethylene vinyl alcohol, and maleic anhydride grafted ethylene vinyl acetate.

17. The composition of claim 13, wherein said fluorophores are quantum dots comprising a material selected from the group consisting of CuInS₂, CuInSe₂, AgInS2, AgInSe2, ZnS, ZnSe, CuAlS2, and alloys of the foregoing.

18. The composition of claim 13, further comprising polymers that have oxygen or water barrier properties that protect the fluorophores from long term degradation.

19. The composition of claim 13, wherein said copolymer contains additives for stabilizing polymers against degradation.

20. The composition of claim 13, wherein said copolymer contains anti-oxidants or other sacrificial additives for slowing oxygen ingress.
